(19) United States
(12) Patent Application Publication
(10) Pub. No.: US 2024/0175469 A1
(43) Pub. Date: May 30, 2024

(54) YIELDING COUPLING WITH RESILIENT INTERMEDIATE MEMBERS

(71) Applicant: RENOLD PLC, Wythenshawe, Manchester (GB)

(72) Inventor: Paul Richards, Chepstow (GB)

(73) Assignee: RENOLD PLC, Wythenshawe, Manchester (GB)

(21) Appl. No.: 18/551,432

(22) PCT Filed: Mar. 21, 2022
(86) PCT No.: PCT/GB2022/050707

§ 371 Date: Sep. 20, 2023

(30) Foreign Application Priority Data
Mar. 22, 2021 (GB) 2103966.4

(51) Int. Cl. F16D 3/12

(52) U.S. Cl. CPC F16D 3/12

(57) ABSTRACT

A mechanical coupling is disclosed. The mechanical coupling includes a first coupling member and a second coupling member. The first and second coupling members each include a body having a first end and an opposed second end. The body defines a central axis. Each coupling member further includes at least one finger that extends from the body in the direction of the central axis and a recess that extends radially into the body, the recess extending between the first end and the second end of the body. The recess has a base that includes at least one channel. The coupling further includes a first resilient member received in the recess of the first coupling member and a second resilient member received in the recess of the second coupling member. The first and second resilient members each include at least one projection that is configured to be received by the channel of the recess of the respective first coupling member or of the second coupling member.

### FIELD OF INVENTION

The present invention relates to mechanical couplings and coupling elements and resilient members for mechanical couplings. The present invention has particular, but not exclusive, application in mechanical couplings in which a rotational movement has to be transferred.

### BACKGROUND

Couplings are generally used to transmit rotational motion from one system to another, translating both rotational speed and torque in the process. Important to the performance of a coupling is the ability to accommodate misalignment, which inevitably occurs when two pieces of machinery and corresponding drive shafts are brought together. The coupling acts as a means of relieving repeated cyclical loads induced by such misalignment. The misalignment can take the form of axial displacement, where the two shafts are parallel but the centres are offset relative to each other, or angular displacement, where the line of intersection of the axes of the mating shafts form an angle at the centre of the coupling greater than zero degrees. In practice, the misalignment in an installation will likely include both elements.

Typically, a conformable element or elastomeric separator is employed between two halves or parts of a coupling to manage the misalignment, but also to accommodate any vibrational torque transmitted from the driver to the driven part of the system and/or from the driven part to the driver. Couplings are known that provide elastic parts than can take care of lateral and/or angular misalignments and damp vibrations.

WO2017/167936 describes a mechanical coupling for transmission of a rotational movement around an axis of rotation. The coupling comprises two separate, identically shaped coupling parts in which at least of one of the coupling parts can be fixed to a torque-transmitting element. Each of the coupling parts has at least one protruding element that fits into a recess of the other coupling part and at least one elastic element is provided between a wall of at least one recess and a protruding element that fits into the recess. At least one of the elastic elements comprises at least two legs, wherein at least two legs fit on different sides of the protruding element between the protruding element and the side walls of the recess, and wherein the two legs are connected by at least one bottom part. This coupling is configured in this way to reduce the number of different components in order to reduce complexity and keep cost to a minimum as well as to allow easy maintenance and adjustable performance.

In existing couplings having resilient members, the resilient members can move over time in use and in some circumstances may even become fully displaced.

It is an object of the present invention to obviate or mitigate one or more of the problems currently associated with mechanical couplings.

### SUMMARY OF INVENTION

According to a first aspect of the present invention, there is provided a mechanical coupling comprising: a first coupling member and a second coupling member, said first and second coupling members each comprising: a body having a first end and an opposed second end, the body defining a central axis; at least one finger that extends from the body in the direction of the central axis; and a recess that extends radially into the body, the recess extending between the first end and the second end of the body, said recess having a base, the base of the recess comprising at least one channel; the coupling further comprising a first resilient member received in the recess of the first coupling member and a second resilient member received in the recess of the second coupling member; wherein the first and second resilient members each comprise at least one projection which is configured to be received by the channel of the recess of the respective first coupling member or of the second coupling member.

By providing a channel in the recesses of the first and second resilient members and by also providing a corresponding projection on the first and second resilient members, the first and second resilient members are held in place more securely. In existing couplings without such a channel, the base of the recesses is smooth and there is nothing to prevent the resilient members disposed in the recesses from rotating out of the desired position. In this way, the present invention provides for more secure fitment and retainment of the resilient members. The channel is preferably provided in the central region of the base. There may be one or more channels within each recessed portion.

The channel may be in the form of an area which is stepped down from the remainder of the channel. As such, when viewed in cross-section, the base of the recess may be discontinuous, namely the base does not form a smoothly curved line, but rather has one or more distinctive changes of direction. There may be two or more channels. Where there are two or more channels, the channels may be separated by one or more raised portions as necessary. The one or more raised portions may extend from the base. As such, the base may include two or more channels separate by a raised intermediate portion. By extending in the direction of the central axis, it is to be understood that this direction is the same direction as the direction of the central axis, and is preferably substantially parallel to the direction of the central axis. As such, the at least one finger may be substantially parallel to the central axis.

The term “projection” may be understood to mean that the resilient members each comprise a portion that extends from the respective resilient member that provides at least part of each resilient member with a raised profile.

The mechanical coupling may be a flexible coupling. The recess may extend in the direction of the central axis. The channel of the recess may extend in the direction of the central axis. The channel of the recess may extend radially into the base of the recess.

The channel may be substantially u-shaped. The channel may have a floor and two sides. The two sides may be oriented substantially orthogonally with respect to the floor. In embodiments, the two sides are substantially parallel to one another. In embodiments, the radially outer ends of the two sides are closer together than the radially inner sides. In other embodiments, the radially inner ends of the two sides are closer together than the radially inner sides. In embodiments, the sides form an angle of between 80 to 120° with respect to the floor. By having the sides at approximately right angles to the floor, the faces of the sides are able to engage with corresponding faces on the resilient members to prevent unwanted rotation and/or displacement of the resilient members. The transition between the floor and the sides may be curved or radiused.

A projection of the first and second resilient members may be referred to as a protrusion. At least part of each resilient member may engage a finger of at least one of the first coupling member and the second coupling member.

The first and second coupling members may each comprise a plurality of fingers. The first and second coupling members may each comprise an array of fingers. Where the first and second coupling members each comprise a plurality of fingers, the features disclosed in relation to the finger apply to the plurality of fingers mutatis mutandis. Where the first and second coupling members each comprise an array of fingers, the features disclosed in relation to the finger apply to the array of fingers mutatis mutandis. The coupling members may comprise any suitable number of fingers. As such, each coupling member may comprise 1, 2, 3, 4, 5, 6, 7, 8, 9, or more fingers. Preferably, the first coupling member is the same as the second coupling member.

The first and second coupling members may each comprise a plurality of recesses. The first and second coupling members may each comprise an array of recesses. Where the first and second coupling members each comprise a plurality of recesses, the features disclosed in relation to the recess apply to the plurality of recesses mutatis mutandis. Where the first and second coupling members each comprise an array of recesses, the features disclosed in relation to the recess apply to the array of recesses mutatis mutandis.

The mechanical coupling may comprise a plurality of resilient members. The mechanical coupling may comprise an array of resilient members. Where the mechanical coupling comprises a plurality of resilient members, the features disclosed in relation to the resilient member apply to the plurality of resilient members mutatis mutandis. Where the mechanical coupling comprises an array of resilient members, the features disclosed in relation to the resilient member apply to the array of resilient members mutatis mutandis.

The mechanical coupling may be for coupling a first rotating body to a second rotating body. The mechanical coupling may be for coupling a first shaft to a second shaft. The first coupling member may be connected to a first shaft. The second coupling member may be coupled to a second shaft. The mechanical coupling may be for coupling a first flange to a second flange. The first coupling member may be connected to a first flange. The second coupling member may be coupled to a second flange.

Drive shafts of equipment do not rotate perfectly smoothly and are subject to some degree of rotational vibration in use. Therefore, as a shaft coupling rotates it is subject to the vibrations of the drive shaft. The resilient member is provided to absorb at least some of the torsional vibration that the shafts are subjected to in use. Because drive shafts usually rotate in a particular direction for the majority of their operational life, the coupling is subjected to the same or similar vibrational loading patterns during use. The vibrations can cause the resilient member to ride out of the recesses in which they are located. This may be due to rotation of the resilient members or displacement. However, owing to the coupling being subjected to the same or similar vibrational loading pattern during use, the coupling is unlikely to be subjected to vibrational loading that can cause the resilient member to ride back in to the recesses. Therefore, the resilient member can ride out of the recesses in which they are located, but it is unlikely that the resilient member can ride back in to the recesses. If a resilient member rides out of the recess in which it is held, the flexible coupling is no longer able to absorb torsional vibration. Failure of the flexible coupling to absorb torsional vibration can result in damage to components of the system that the mechanical coupling forms a part of. Since the projection of the resilient member is located in a respective channel of the recess of the first member or the second member, the resilient member is advantageously constrained within the recess in which it is located. Therefore, the resilient member is better constrained and so riding out of the resilient member from the recess in which it is positioned is reduced

The shape of the projection of each resilient member may be complementary to the shape of the channel of the recess.

Since the shape of the projection is complementary to the shape of the channel of the recess, there is a greater amount of contact between the surface of the projection and the surface of the channel. This improves retention of the resilient member within the channel, therefore further reducing the likelihood that the resilient member rides out of the recess in which it is located.

The recess may extend from a first end face of the first end to a second end face of the second end of the respective body.

To change a resilient member of a known coupling, the coupling must be removed from the shafts to which it is connected. The members of the coupling must then be separated to allow access to the resilient members. The resilient members can then be removed and replaced, and the coupling then reassembled and reconnected to the shafts.

Since the recess extends from a first end surface to an opposed second end surface of the body, the resilient members can be removed and replaced in situ. This is because access to the recess is provided and so access to the resilient member is also provided. Once the coupling is stationary, the resilient member can be slid axially out of the coupling and a new resilient member inserted into the recess of the respective member of the resilient coupling. This process does not require the first member and the second member to be separated.

The channels may extend from the first end surface to the second end surface of the respective body of the first coupling member and/or the second coupling member.

Since the channels extend from the first end surface to the second end surface, insertion and removal of the at least one resilient member is further aided. This is because access to the channel is provided without a part of the first or second coupling member hindering access to the channel.

The fingers may comprise a free first end and a second end, the second end being connected to the respective body.

The fingers may be integrally formed with the body. The fingers may be separately formed from the body and may be connected to the body by any suitable means. For example, the fingers may be connected to the body with an adhesive, with a weld, or with a fastener. The free first end may be referred to as a distal end. The second end may be referred to as a proximal end.

A finger of the first coupling member and/or a finger of the second coupling member may comprise a respective groove. The groove of each finger may be located adjacent to an end surface of the respective finger. The grooves may be offset from an end surface of the respective finger along the central axis. The grooves may be configured to receive a retaining ring.

The groove may be a circumferential groove. Circumferential groove may be understood to mean a groove that extends in the generally circumferential direction. The groove may extend in the circumferential direction. The retaining ring may be a circlip. The retaining ring may be a spiral retaining ring.

The groove of the finger of the first member may be positioned axially beyond the second end of the finger of the second member. Alternatively or additionally, the groove of the finger of the second member is positioned axially beyond the second end of the finger of the first member. The groove preferably faces inwardly. The groove is preferably formed on an inner face of a finger. In other embodiments, the grove may face outwardly. In such embodiments, the groove may be formed on an outer face of a finger.

Since the finger of the first coupling member and/or of the second coupling member can comprise a groove that is configured to receive a retaining ring, the likelihood of axial separation of the first coupling member from the second coupling member is advantageously reduced by providing a retaining ring to the groove of the finger of one or both of the first and second coupling members. During operation, the coupling can be subjected to axial loads that can result in axial separation of the first coupling member from the second coupling member, or vice versa. This is undesirable because axial separation can result in uncoupling of the first coupling member from the second member, therefore preventing the mechanical coupling from coupling a first shaft to a second shaft.

The groove of the finger of the first member may be positioned at least partially axially beyond the second end of the finger of the second member. Optionally or additionally, the groove of the finger of the second member is positioned axially beyond the second end of the finger of the first member. The groove may face inwardly towards the central axis or may face outwardly away from the central axis.

Since the recess of the finger of the first member can be positioned axially beyond the second end of the finger of the second member, where a retaining clip is received in the groove of the finger of the first member, the retaining clip advantageously abuts the second end of the finger of the second member. Similarly, since the recess of the finger of the second member can be positioned axially beyond the second end of the finger of the first member, where a retaining clip is received in the groove of the finger of the second member, the retaining clip advantageously abuts the second end of the finger of the first member. This constrains axial movement of the second member with respect to the first member and vice versa. This is because the retaining clip abuts the second end of the respective finger, which acts to constrain axial movement of the respective one of the first and second members. Therefore, if the one of the members is subject to an axial load, movement of the first member with respect to the second member, and vice versa, is constrained.

The mechanical coupling may further comprise comprising a first retaining ring received in the groove of the first coupling member and a second retaining ring received in the groove of the second coupling member. The first and/or second retaining ring may be a circlip. The first and/or second retaining ring may be a spiral retaining ring.

The first retaining ring may abut the second end of the finger of the second member. Alternatively or additionally, the second retaining ring abuts the second end of the finger of the first member.

Abutment between the retaining rings and a second end of a finger of a respective resilient member advantageously constrains movement of the resilient member. This reduces the likelihood that the resilient members can ride out of the recess in which they are located during use.

The fingers may be located radially outwards of a respective body.

The fingers being located radially outwards of a respective body contributes towards allowing the resilient members to be replaced in situ. This is because the resilient members can be accessed and removed from the coupling more easily compared to if the fingers were, for example, flush with the respective body. This allows simple inspection, servicing, maintenance and repair of the coupling.

In addition, the fingers being located radially outwards of a respective body also advantageously reduces the load that is exerted by the fingers on the resilient members. This is because increasing the distance from the central axis of the coupling member to the area of contact between the fingers and the body reduces the load that the resilient members are subject to in use.

The first member and the second member may comprise a plurality of fingers, the plurality of fingers of the first member interdigitating with the plurality of fingers of the second member.

Providing a plurality of fingers allows improved stress distribution because the torque that is transferred by the coupling is transferred by numerous fingers of each member, rather than a single finger of each member. Any suitable number of fingers may be provided and the invention is not particularly limited by the number of fingers.

The channel of the first coupling member and the channel of the second member may define respective sidewalls. The sidewalls may be linear or may be curved. The sidewalls may comprise one or more slots and/or protrusions for engaging with a corresponding slot and/or protrusion on the resilient elements. The resilient member may abut the sidewalls of the channel of the recess in which the projection is received.

The sidewalls may extend parallel to one another. The sidewalls may be parallel to the radial direction. In other words, the sidewalls may extend parallel to the radial direction.

The sidewalls may taper inwardly in the radially inward direction. The sidewalls may taper outwardly in the radially inward direction. Taper inwardly in the radially inward direction may be understood to mean that the distance between the sidewalls decreases in the radially inward direction. Similarly, taper outwardly in the radially inward direction may be understood to mean that the distance between the sidewalls increases in the radially inward direction.

The first and second resilient members may each comprise a central portion having a first side and an opposed second side, and two legs that extend from the first side and define a channel therebetween.

The first side may be a radially outer side of the central portion. The second side may be a radially inner side of the central portion.

The finger of the first coupling member may be received by the channel of the second resilient member. The finger of the second coupling member may be received by the channel of the first resilient member.

The central portion of the first and second resilient members may each define a first end that faces a central portion of the mechanical coupling and an opposed second end face.

The legs of the first and second resilient members may each define a first end that faces a central portion of the coupling and an opposed second end.

Each leg may comprise a location feature. The location feature may be for widening an opening the respective channel. The location feature may be adjacent to the first end of the respective leg. The location feature may be a chamfer or a radius.

The location feature assists with locating the fingers of the coupling member in the respective channel, which advantageously assists with assembly of the coupling.

The second end of the legs of the first resilient member may be located axially adjacent to the groove of the finger of the second member. The second end of the legs of the second resilient member may be located axially adjacent to the groove of the finger of the first member.

Since the second ends of the legs of the resilient members can be axially adjacent to the groove of the finger of a respective one of the first member and the second member, where the grooves of the fingers receive a retaining clip, axial movement of the resilient members is advantageously constrained.

The second end of the legs of the first and second resilient members may be configured to abut a respective retaining clip.

The second end of the legs of the first and second resilient members may be axially spaced apart from the second end of the respective central portion.

The first end of the first side of the central portion of each of the first and second resilient members may comprise a chamfer.

Where the first end of the first side of the central portion of the resilient members comprises a chamfer, locating the fingers within the channels of the resilient members is aided.

The first end of the second side of the central portion of the first and second resilient members may comprise a chamfer.

The projection of the first and second resilient members may extend along a full axial length of the respective resilient member.

Since the projection extends from the first end to the second end of the resilient member, engagement between the projection and the channel of the recess of the respective member is advantageously maximised. Maximisation of the engagement between the projection and the channel advantageously aids constraining of the resilient member within the recess.

According to a second aspect of the present invention, there is provided a coupling member for a mechanical coupling, the coupling member comprising: a body having a first end and an opposed second end, the body defining a central axis; at least one finger that extends from the body in the direction of the central axis; and a recess that extends radially into the body, the recess extending between the first end and the second end of the body, said recess having a base, characterised in that the base of the recess includes a channel.

The coupling member according to the second aspect of the present invention may be engaged with a second coupling member and respective resilient members to form a coupling according to the first aspect of the present invention. As such, each of the features described in respect of the first aspect of the present invention apply equally to the second aspect of the present invention.

According to a third aspect of the present invention, there is provided a resilient member for use in a mechanical coupling, said resilient member including: a central portion that defines a first side and a second side, and a projection which projects from a second side of the central portion, and/or wherein the resilient member includes a first face and an opposed second face, at least of said first and second faces including a boss.

The projection may be configured to engage with a corresponding portion of a first and/or second coupling member.

The resilient member may further comprise a central portion having a first side and an opposed second side, two legs that extend from the first side of the central portion and that define a channel therebetween.

According to a fourth aspect of the present invention, there is provided a mechanical coupling comprising: a first coupling member and a second coupling member, said first and second coupling members comprising: a body having a first end and an opposed second end, the body defining a central axis; at least one finger that extends from the body in the direction of the central axis, the at least one finger comprising a groove configured to receive a retaining ring; and a recess that extends radially into the body, the recess extending between the first end and the second end of the body, the coupling further comprising at least one resilient member disposed between the first coupling member and the second coupling member, wherein the mechanical coupling includes a retaining ring received in the groove of the at least one finger and wherein the retaining ring is configured to retain the at least one resilient member.

According to this aspect of the present invention, the resilient members are retained in position by a retaining ring which engages with a groove in a finger of the coupling members. In existing couplings, the resilient members are not axially retained and may therefore become displaced during normal usage.

The finger of the first coupling member and the finger of the second coupling member may each comprise a free first end and a second end, the second end being connected to the respective body.

The recess of each coupling member may comprise a base. The base of each recess may comprise a channel. The at least one resilient member may comprise a plurality of resilient members. Each of the plurality of resilient members may be received in a recess of a respective coupling member. The at least one resilient member may comprise at least one projection. The at least one projection of each resilient member may be configured to be received by the channel of the recess of the respective coupling member.

The groove of the finger of the first member may be positioned axially beyond the second end of the finger of the second member. The groove of the finger of the second member may be positioned axially beyond the second end of the finger of the first member.

In such embodiments, as the recess of the finger of the first member is positioned axially beyond the second end of the finger of the second member, where a retaining clip is received in the recess of the finger of the first member, the retaining clip advantageously constrains axial movement of the second member with respect to the first member and vice versa. Therefore, if the one of the members is subject to an axial load, movement of the first member with respect to the second member (and vice versa) is constrained.

The coupling member may comprise a retaining ring received in the groove of a finger. The mechanical coupling may further comprise a first retaining ring received in the groove of the first coupling member and a second retaining ring received in the groove of the second coupling member. The first retaining ring may abut the second end of the finger of the second member. Alternatively or additionally, the second retaining ring may abut the second end of the finger of the first member.

According to a fifth embodiment of the present invention, there is provided a coupling member for a mechanical coupling, the coupling member comprising: a body having a first end and an opposed second end, the body defining a central axis; a recess that extends radially into the body, the recess extending between the first end and the second end of the body; and at least one finger that extends from the body in the direction of the central axis; characterised in that the at least one finger includes a groove that is configured to receive a retaining ring.

The groove may be a circumferential groove. The groove may extend in the circumferential direction. The retaining ring may be a circlip. The retaining ring may be a spiral retaining ring. The groove may be located on an inner face of the at least one finger. The groove may face towards the central axis. Alternatively, the groove may be located on an outer face of the at least one finger. The groove may face away from the central axis.

It will be appreciated that features described above with reference to one aspect of the invention may be combined with another aspect of the invention as appropriate. As such, the features of any elements described in respect of one aspect of the present invention equally apply to corresponding features described in any other aspect of the present invention. Each of the component parts of each aspect of the present invention may be used or combined with any of the component parts described in any aspect of the present invention. All such combinations are expressly considered and disclosed.

### BRIEF DESCRIPTION OF THE DRAWINGS

Embodiments of the present invention will now be described, by way of example only, with reference to the accompanying drawings in which:

FIG. 1 depicts a perspective view of a mechanical coupling in accordance with an embodiment of the present invention;

FIG. 2 depicts a perspective view of a coupling member of the mechanical coupling FIG. 1;

FIG. 3 depicts an end-on view of the coupling member of FIG. 2;

FIG. 4 depicts a radial view of a finger of the coupling member of FIG. 2;

FIG. 5 depicts a perspective view of a resilient member of the mechanical coupling of FIG. 1;

FIG. 6 schematically depicts an exploded view of the mechanical coupling of FIG. 1; and

FIG. 7 depicts a finite element analysis model of the stress distribution of the mechanical coupling of FIG. 1.

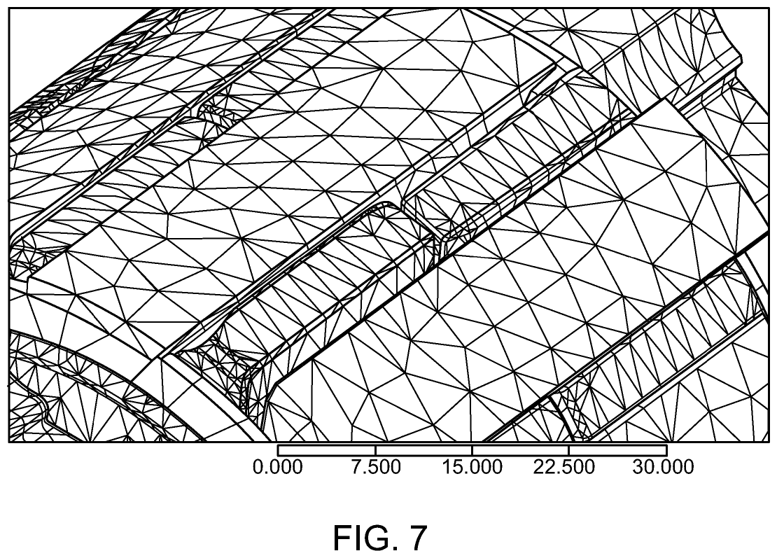

### DETAILED DESCRIPTION

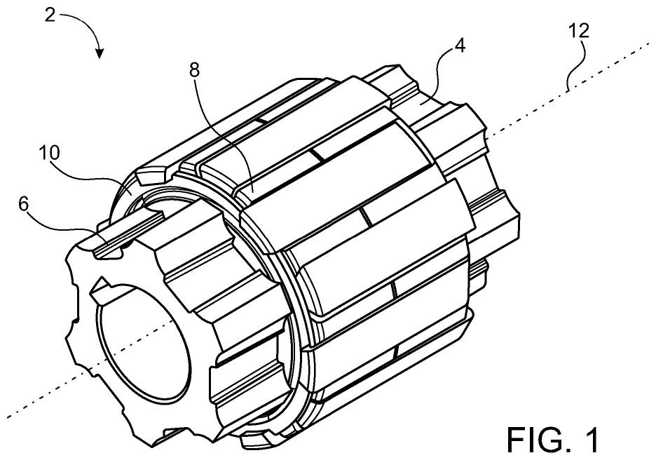

Referring firstly to FIG. 1, a coupling 2 is depicted. The coupling 2 can be used to connect a first shaft (not shown) to a second shaft (not shown). The coupling 2 can be used to transfer a torque of at least 5 Nm. In some embodiments, the coupling 2 can be used to transfer a torque of at least 340 kNm. The coupling 2 comprises a first coupling member 4 and a second coupling member 6. The first coupling member 4 is identical to the second coupling member 6. In other, non-depicted embodiments, the first coupling member 4 can be non-identical to the second coupling member 6. This may include the second coupling member 6 having a different shape, size or material of the first coupling member 4. The coupling 2 further comprises a plurality of resilient members 8 (only one of the resilient members is labelled in FIG. 1). Since the coupling 2 comprises a plurality of resilient members 8, the coupling may be referred to as a flexible coupling. The coupling further comprises a first retaining ring 10 and a second retaining ring (not visible in FIG. 1). The first retaining ring 10 is received by the first coupling member 4 and the second retaining ring is received by the second coupling member 6, as will be discussed in more detail below. The first and/or second retaining ring 10 may be a circlip. The first and/or second retaining ring 10 may be a spiral retaining ring. In other non-depicted embodiments, a retaining ring is not provided. Further, in other, non-depicted embodiments, the retaining ring need not be a circlip and can be another suitable type of retaining ring. The coupling 2 defines a coupling axis 12. In use, the coupling 2 rotates about the coupling axis 12.

The first and second coupling members 4, 6 can be made of a metallic material. Suitable metallic materials include, for example, cast iron, steel, aluminium, magnesium-titanium alloys or Inconel®. The first and second coupling members 4, 6 can be made of a non-metallic material. Suitable non-metallic materials include plastics, carbon fibre, glass-reinforced plastics or any fibre-impregnated material. It will be appreciated that the material that the first coupling member 4 is made of can be different to the material that the second coupling member 6 is made of.

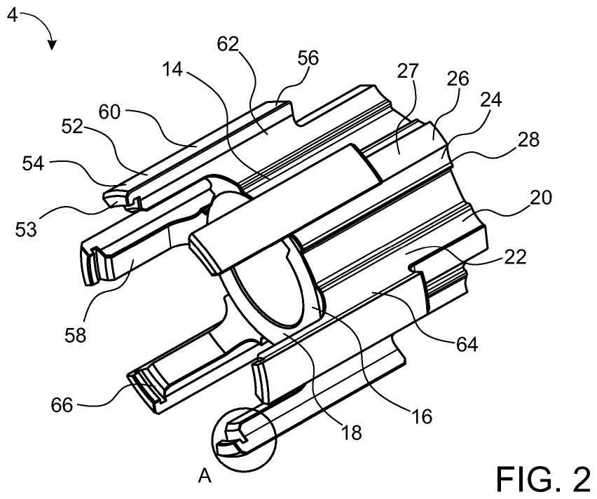

The first coupling member 4 will now be described with reference to FIG. 2. The first coupling member 4 comprises a body 14. The body 14 is generally annular. In other, non-depicted embodiments, the body can be any other suitable shape. The body 14 comprises a first end 16 and a second end (not visible in FIG. 2). The second end is opposed to the first end 16. The first end 16 comprises a first end face 18. The second end comprises a second end face (not visible in FIG. 2).

The first coupling member 4 further comprises a plurality of recesses 20 (only one recess is labelled in FIG. 2). The recesses of the plurality of recesses 20 extend in the direction of the coupling axis (not shown in FIG. 2). In the depicted embodiment, the first coupling member 4 comprises six recesses 20. In other, non-depicted embodiments, the first coupling member can comprise any suitable number of recesses. The recesses of the plurality of recesses 20 extend radially into the body 14. The recesses of the plurality of recess 20 extend from the first end face 18 to the second end face of the body 14. Therefore, the recesses of the plurality of recesses 20 extend along the full axial length of the body 14 of the first coupling member 4. In other, non-depicted embodiments, the recesses of the plurality of recesses can be offset from the first end face and/or the second end face of the body and therefore may not necessarily extend the whole length of the body. The plurality of recesses 20 is provided as an array. That is to say, the recesses of the plurality of recesses 20 are distributed evenly about the body 14 of the first coupling member 4. In other, non-depicted, embodiments the recesses of the plurality of recesses are distributed in a non-even fashion about the first coupling member. The recesses of the plurality of recesses 20 each define a first sidewall 22 (only one of the first sidewalls is labelled in FIG. 2) and a second sidewall 24 (only one of the second sidewalls is labelled in FIG. 2). The first and second sidewalls 22, 24 extend parallel to the coupling axis. A maximum width of the recesses 20 is defined as the maximum distance between the sidewalls 22, 24. The maximum width may be at least 8 mm. The maximum width may be equal to or less than 185 mm. Defined between adjacent recesses of the plurality of recesses 20 are a plurality of ridges 26 (only one of the ridges is labelled in FIG. 2). The ridges of the plurality of ridges 26 each comprise a ridge surface 27 (only one of the ridge surfaces is labelled in FIG. 2). The recesses of the plurality of recesses 20 each comprise a respective base 28 (only one of the bases is labelled in FIG. 2). The base extends between the first and second sidewalls 22, 24. As explained in more detail below, the base 28 includes a channel 30.

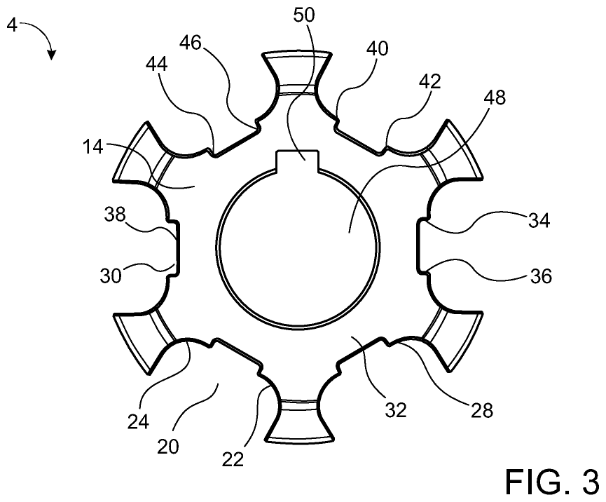

Referring now to FIG. 3, the first coupling member 4 further comprises a plurality of channels 30 (only one of the channels is labelled in FIG. 3). The channels of the plurality of channels 30 are located at the base 28 of each recess of the plurality of recesses 20. Each channel 30 extends from the first end face (not visible in FIG. 3) to the second end face 32 of the body 14. In other, non-depicted embodiments, one or more of the channels can be offset from the first and/or second end face of the body.

Each channel of the plurality of channels 30 comprises a first sidewall 34, a second sidewall 36 and a base surface 38, which may also be referred to as a floor. In the depicted embodiment, the first and second sidewalls 34, 36 extend parallel to one another. In other, non-depicted, embodiments, the first and second sidewalls can extend parallel to the radial direction. In further, non-depicted, embodiments, the first and second sidewalls can taper inwardly in the radially inward direction. That is to say, the distance between the sidewalls can decrease in the radially inward direction. In further, non-depicted, embodiments, the first and second sidewalls can taper outwardly in the radially inward direction. That is to say, the distance between the sidewalls can increase in the radially inward direction. A width of each channel is defined by the distance between the sidewalls 34, 36 of each channel of the plurality of channels 30. The width of the channels of the plurality of channels 30 may be at least 3 mm. The width of the channels of the plurality of channels 30 may be equal to or less than 75 mm.

The sidewalls 22, 24 of each recess of the plurality of recesses 20 each adjoin a respective radiused surface 40, 42. The radiused surfaces 40, 42 also adjoin a respective sidewall 34, 36 of a respective channel of the plurality of channels 30. The sidewalls 34, 36 of each channel of the plurality of channels 30 each adjoin a respective radiused section 44, 46. The radiused sections 44, 46 also adjoin the base surface 38 of the respective channel 30.

As can be seen in FIG. 3, the first and second sidewalls 22, 24 of each recess of the plurality of recesses 20 are concave. Therefore, the first and second sidewalls 22, 24 of each recess of the plurality of recesses 20 define an undercut. The undercuts of each recess are configured to engage with a respective resilient member to assist in the prevention of displacement of the resilient members. In particular, the undercuts are configured to engage with a respective resilient member to assist in the prevention of radial displacement of the resilient members. In other, non-depicted embodiments, the first and second sidewalls of each recess of the plurality of recesses can be convex. In other, non-depicted embodiments, the first and second sidewalls of each recess of the plurality of recesses can be generally planar.

The body 14 of the first coupling member 4 comprises a bore 48. The bore 48 extends from the second side 32 of the body 14 to the first side. The bore 48 is provided with an optional keyway section 50. The keyway section 50 allows the first coupling member 4 to be secured to a shaft (not shown). To do this, a shaft with a corresponding keyway is provided. A key is inserted into the keyway of the shaft and the shaft and key are inserted into the bore 48 such that the corresponding key is located within the keyway section 50 of the bore.

Referring again to FIG. 2, the first coupling member 4, further comprises a plurality of fingers 52 (only one of the fingers is labelled in FIG. 2). The fingers of the plurality of fingers 52 extend from the body 14 of the first coupling member 4. The fingers of the plurality of fingers 52 are located radially outwards of the body 14. In other, non-depicted, embodiments the fingers of the plurality of fingers can be located radially inwards of the body. The fingers of the plurality of fingers 52 extend generally in the direction of the coupling axis (not shown in FIG. 2). That is to say, the fingers of the plurality of fingers 52 extend generally parallel to the coupling axis. The plurality of fingers 52 is provided as an array. That is to say, the fingers of the plurality of fingers 52 are distributed evenly about the body 14 of the first coupling member 4. In other, non-depicted, embodiments the fingers of the plurality of fingers are distributed in a non-even fashion about the first coupling member.

The fingers of the plurality of fingers 52 each comprise a first end 54 and a second end 56. The first end 54 is free. That is to say, the fingers of the plurality of fingers 52 are cantilevered from the body 14 of the first coupling member 4. The first end 54 can also be referred to as a distal end or a distal portion. The second end 56 is opposed to the first end 52. The first end 54 of each finger of the plurality of fingers 52 comprise an end surface 53. The second end 56 of each finger of the plurality of fingers 52 comprise an end surface (not visible in FIG. 2). In certain embodiments, the distance in the direction of the coupling axis (not shown in FIG. 2) from the end surface 53 of the first end 54 to the first end face 18 of the body 14 of the first coupling member 4 is greater than the distance from the end surface of the second end 56 to the first end face of the body.

Therefore, once assembled, the end surfaces 53 of the first ends 54 of the fingers of the plurality of fingers 52 of the first coupling member 4 are located axially beyond the end surfaces of the second ends 56 of the fingers of the plurality of fingers of the second coupling member 6. In other, non-depicted, embodiments the distance in the direction of the coupling axis from the end surface of the first end to the first end face of the body of the first coupling member can be less than or equal to the distance from the end surface of the second end to the first end face of the body. A length of each finger of the plurality of fingers 52 is defined by the distance from the end surface 53 of the first end 54 to the end surface of the second end 56. The length of each finger of the plurality of fingers 52 may be at least 15 mm. The length of each finger of the plurality of fingers 52 may be equal to or less than 400 mm.

The fingers of the plurality of fingers 52 each comprise a radially inner surface 58 (only one of the radially inner surfaces is labelled in FIG. 2) and a radially outer surface 60 (only one of the radially outer surfaces is labelled in FIG. 2). The distance from the coupling axis to the radially inner surface 58 of each finger of the plurality of fingers 52 is greater than the distance from the coupling axis to the ridge surfaces 27 of the plurality of ridges 27. In other, non-depicted, embodiments the distance from the coupling axis to the radially inner surface of each finger of the plurality of fingers is generally equal to the distance from the coupling axis to the ridge surfaces of the plurality of ridges. In further, non-depicted, embodiments the distance from the coupling axis to the radially inner surface of each finger of the plurality of fingers can be less than the distance from the coupling axis to the ridge surfaces of the plurality of ridges.

The fingers of the plurality of fingers 52 each comprise a first sidewall 62 and a second sidewall 64. The second sidewall 64 is opposed to the first sidewall 62. The first and second sidewalls 62, 64 of each finger of the plurality of fingers define respective longitudinal sides of each finger. The first and second sidewalls 62, 64 of each finger of the plurality of fingers adjoins a respective sidewall 22, 24 of a respective recess of the plurality of recesses 20. The first and second sidewalls 62, 64 of each finger 52 extends tangentially from a respective sidewall 22, 24 of the respective recess of the plurality of recesses 20. The first and second sidewalls 62, 64 are concave. In other, non-depicted, embodiments, the first and second sidewalls can be convex or planar.

The fingers of the plurality of fingers 52 are integrally formed with the body 14 of the first coupling member 4. In other, non-depicted, embodiments the fingers can be separately formed from the body and connected to the body by any suitable means. For example, the fingers of the plurality of fingers can be connected to the body of the first coupling member using an adhesive and/or a suitable fastener and/or through the use of welding.

Each finger of the plurality of fingers 52 comprises a groove 66. In use, the grooves 66 receive the first retaining ring (not shown in FIG. 2). Therefore, the grooves 66 are configured to receive a retaining ring. The groove 66 of each finger of the plurality of fingers 52 is located adjacent to the end surface 53 of the respective finger.

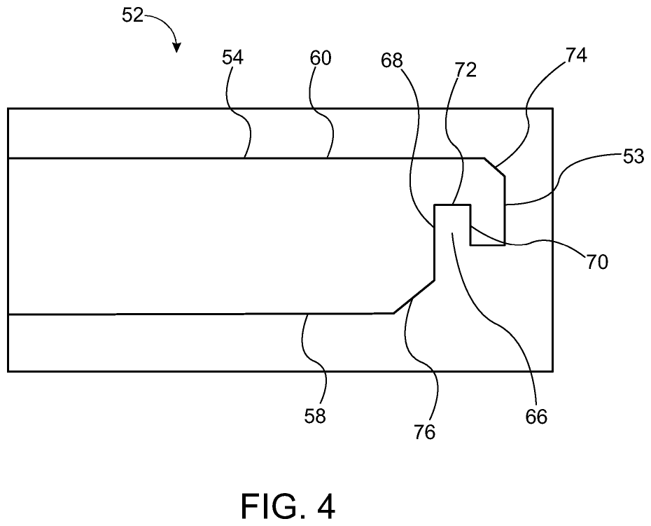

The first end 54 of each finger will now be described with reference to FIG. 4. It will be appreciated that the following description applies to all of the fingers of the plurality of fingers 52. However, the fingers of the plurality of fingers 52 need not be identical and each finger may comprise any combination of features that will be described. FIG. 4 shows a radial view of the finger 52 of section A of FIG. 2. As can be seen, the groove 66 extends radially into the first end 54 of the finger 52. The groove 66 is defined by a first radially extending wall 68, a second radially extending wall 70 and an axially extending wall 72. The axially extending wall 72 adjoins the first and second radially extending walls 68, 70. The first and second radially extending walls 68, 70 extend perpendicularly from the axially extending wall 72. In other, non-depicted, embodiments, the first and second radially extending walls can extend at any suitable angle from the axially extending wall. The radial length of the first radial wall 68 is optionally greater than the radial length of the second radial wall 70. This configuration facilitates receipt of a retaining ring. This is because to insert a retraining ring into the groove, the diameter of the retaining ring is typically manually reduced. Since the length of the second radial wall 70 is less than the length of the first radial wall 68, the amount by which the diameter of the retaining ring needs to be reduced by during assembly is less than if the length of the second radial wall were equal to the length of the first radial wall. In other, non-depicted embodiments, the length of the first radial wall can be less than or equal to the length of the second radial wall. An optional first chamfered surface 74 adjoins the radially outer surface 60 and the end surface 53 of the finger 66. An optional second chamfered surface 76 adjoins the radially inner surface 58 and the first radially extending wall 68 of the groove 66. Together, the grooves 66 of each finger of the plurality of fingers 52 define a diameter. The diameter may be at least 20 mm. The diameter may be less than or equal to 520 mm.

As noted above, in the depicted embodiment the first coupling 4 is identical to the second coupling 6. Therefore, it will be appreciated that the above description of the first coupling member 4 applies equally to the second coupling member 6. It will also be appreciated that the second coupling member 6 can comprise any combination of the features described in relation to the first coupling member 4.

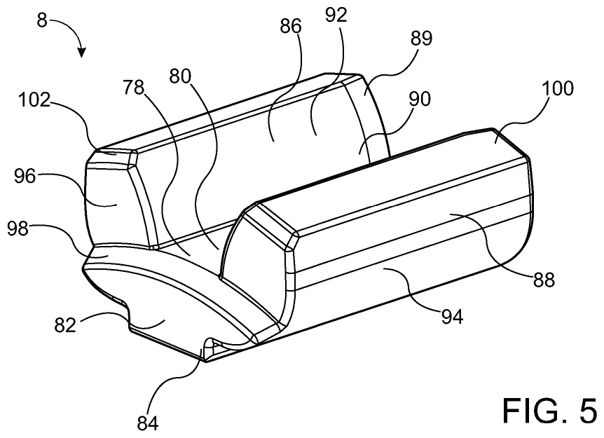

Referring now to FIG. 5, a perspective view of a resilient member of the plurality of resilient members 8 is shown. It will be appreciated that the following description applies to all of the resilient members of the plurality of resilient members 8. However, each resilient member can have any combination of the features described in relation to FIG. 5. The resilient member 8 may be made of any suitable material. For example, the resilient member 8 may be made of an elastomer, a polymer or a composite material. It will be appreciated that the resilient members of the plurality of resilient members 8 need not all be made of the same material. The resilient member 8 can be made by any suitable process. For example, the resilient member 8 can be made via injection moulding.

The resilient member 8 comprises a central portion 78. The central portion 78 may also be referred to as the body of the resilient member 8. The central portion 78 comprises a first side 80 and a second side (not visible in FIG. 5). The first side 80 is a radially outer side of the resilient member 8 and the second side is a radially inner side of the resilient member. The central portion 78 further comprises a first end surface (not visible in FIG. 5) and a second end surface 82. The second end surface 82 is opposed to the first end surface. When assembled into the coupling, the first end surface faces a central portion of the coupling. The distance from the first end surface to the second end surface 82 defines an axial length of the resilient member 8.

The second side of the central portion 78 of the resilient member 8 comprise a projection 84. The projection 84 extends along the full axial length of the resilient member 8. In other, non-depicted, embodiments, the projection can be offset from the first and/or second end surface of the central portion of the resilient member. In further, non-depicted embodiments, the second side of the resilient member can be provided with a plurality of projections. In further non-depicted embodiments, the projection extends part way along the length of the resilient member 8. The shape of the projection 84 is complementary to the shape of the channels of the plurality of channels 30. When the resilient member 8 has been assembled into the coupling, the projection 84 of each resilient member 8 is received by a respective channel of the plurality of channels 30 of a respective one of the first coupling member 4 and the second coupling member 6.

The resilient member 8 further comprises a first leg 86 and a second leg 88. In other, non-depicted, embodiments the resilient member can comprise a different number of legs. For example, the resilient member may comprise a single leg, or may comprise three or more legs. The first and second legs 86, 88 extend from the first side 80 of the central portion 78 of the resilient member. Defined between the first and second legs 86, 88 is a channel or valley 90. When assembled into the coupling, the channel of each resilient member of the plurality of resilient members 8 receives a respective finger of the plurality of fingers 52.

The first leg 86 and the second leg 88 each comprise a first sidewall 92 (the first sidewall of the second leg is not visible in FIG. 5) and a second sidewall 94 (the second sidewall of the first leg is not visible in FIG. 5). The first sidewalls 92 are inwardly facing. That is to say, the first sidewall 92 of the first leg 86 faces towards the first sidewall of the second leg 88. The second sidewalls 94 of each of the first and second legs 86, 88 are outwardly facing. That is to say, the second sidewall of the first leg 86 faces away from the second sidewall 94 of the second leg 88. In the depicted embodiment, the first and second sidewalls 92, 94 are convex. The shape of the first and second sidewalls 92, 94 is complementary to the sidewalls 22, 24 of the recesses of the plurality of recesses 20 and is complementary to the sidewalls first and second sidewalls 62, 64 of the fingers of the plurality of fingers 52. Therefore, it will be appreciated that in embodiment in which the sidewalls 22, 24 of the recesses of the plurality of recesses 20 and/or the sidewalls 62, 64 of the fingers of the plurality of fingers 52 are convex, then the first and second sidewalls 92, 94 of the first and second legs 86, 88 are concave. Similarly, in embodiments in which the sidewalls 22, 24 of the recesses of the plurality of recesses and/or the sidewalls 62, 64 of the fingers of the plurality of fingers 52 are planar, then the first and second sidewalls 92, 94 of the first and second legs 86, 88 are planar.

The first and second legs 86, 88 each comprise a first end (the first ends are not visible in FIG. 5). Each of the first and second legs 86, 88 comprise a second end 96 (only one of the second ends is labelled in FIG. 5). The second end 96 is opposed to the first end. When assembled into the coupling, the second end 96 of each leg 86, 88 is located adjacent to respective grooves 66 of the fingers of the plurality of fingers 52. In particular, when assembled, the distance from the second end 96 of each leg 86, 88 of each resilient member 8 to the first end surface 18 of the body 14 of the coupling member is less than the distance from the groove 66 of each finger of the plurality of fingers 52 to the first end surface 18 of the body 14. The second end 96 of the first and second legs 86, 88 is offset from the second end surface 82 of the central portion 78 of the resilient member 8. In other, non-depicted, embodiments the second end of the first and second legs can be flush with the second end surface of the central portion of the resilient member.

The first and second legs 86, 88 each comprise a chamfered surface 89 (the chamfered surface of the second leg is not visible in FIG. 5). The chamfered surface 89 of each leg 86, 88 adjoins the first end and the first sidewall 92 of a respective leg. The chamfered surfaces 89 defines a location feature that widens the channel 90 at the first end of the legs. The chamfered surface 89 assists with assembly of the coupling 2, as will be discussed in more detail below. In other, non-depicted embodiments, the chamfered surface can be replaced with a radiused surface.

The resilient member 8 further comprises a first chamfered surface (not visible in FIG. 5). The first chamfered surface adjoins the first side 80 of the central portion 78 of the resilient member 8 and the first end surface. The resilient member 8 further comprises a second chamfered surface (not visible in FIG. 5). The second chamfered surface adjoins the second side of the central portion 78 of the resilient member 8 and the first end face. The resilient member 8 further comprises a third chamfered surface 98. The third chamfered surface adjoins the first side 80 of the central portion 78 of the resilient member 8 and the second end face 82. The chamfered surfaces 98 facilitate assembly of the resilient member into the coupling. Furthermore, the chamfered surfaces aid removal of the resilient member from the mould used to form the resilient member 8 during manufacture. The chamfered surfaces are each optional.

Each leg 86, 88 comprises a respective radially outer surface 100 (only one of the radially outer surfaces is labelled in FIG. 5). When assembled into the coupling, the radially outer surface 100 of each leg 86, 88 is generally flush with the radially outer surfaces 60 of the fingers of the plurality of fingers 52. In other, non-depicted, embodiments the radially outer surfaces of the legs can be offset from the radially outer surfaces of the fingers of the plurality of fingers in the radially inward or radially outward direction. It will be appreciated that the radially outer surfaces of some legs can be located radially inwards of the radially outer surfaces of the fingers of the plurality of fingers and others can be located radially outwards of the radially outer surfaces of the fingers. An optional chamfered surface 102 (only one of the chamfered surfaces is labelled in FIG. 4) is provided that adjoins the second end 96 and the radially outer surface 100 of each leg.

The boundaries between adjacent surfaces of the resilient member 8 are provided with radii (the radii are not labelled in the Figures). In particular, radii are provided between adjacent surfaces where the angle between adjacent surfaces is less than 60 degrees. This is as opposed to the boundaries being defined by edges. In other, non-depicted, embodiments the boundaries between adjacent surfaces of the resilient member can be provided with chamfers. Providing the boundaries between adjacent surfaces with radii or chamfers advantageously aids removal of the resilient from the mould that is used to form the resilient member during manufacture.

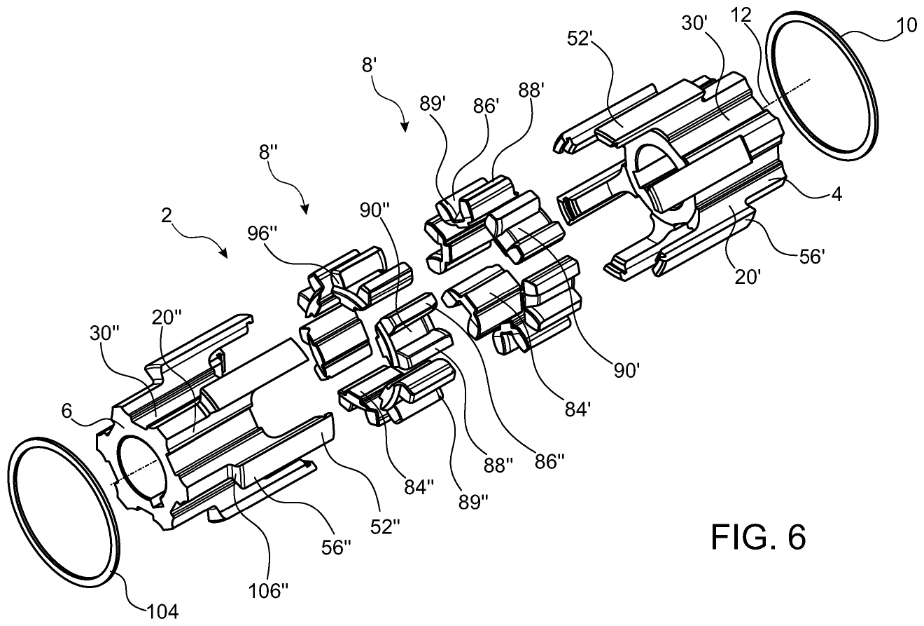

Referring now to FIG. 6, an exploded view of the coupling 2 is depicted. As can be seen, the first coupling member 4 is rotationally offset from the second coupling member 6. The first coupling member 4 is rotationally offset from the second coupling member 6 by 30 degrees. The amount of rotational offset is determined by the number of fingers provided to each coupling member 4, 6. Therefore, in other, non-depicted, embodiments the amount of rotational offset can be greater than or less than 30 degrees. The rotational offset of the first and second coupling members 4, 6 allows the plurality of fingers 52′ of the first coupling member to interdigitate with the plurality of fingers 52″ of the second coupling member. Therefore, when the coupling 2 is assembled, the fingers of the plurality of fingers 52′ of the first coupling member 4 are located within the recesses 20″ of the second coupling member 6, and the fingers of the plurality of fingers 52″ of the second coupling member are located within the recesses 20′ of the first coupling member.

As can be seen, the plurality of resilient members of the coupling 2 comprises a first group of resilient members 8′ and a second group of resilient members 8″. The first group of resilient members 8′ are received by the plurality of recesses 20′ of the first coupling member 4. The second group of resilient members 8″ are received by the plurality of recesses 20″ of the second coupling member 6. Therefore, when the coupling has been assembled, the fingers of the plurality of fingers 52′ of the first coupling member 4 are each received by a respective channel of the plurality of channels 90″ of the second group of resilient members 8″. Similarly, the fingers of the plurality of fingers 52″ of the second coupling member 6 are each received by a respective channel of the plurality of channels 90′ of the first group of resilient members 8′. Therefore, interposed between adjacent fingers of the plurality of fingers 52′, 52″ is a leg 86′, 88′, 86″, 88″ (the legs of only one of the resilient members of each group is labelled in FIG. 6) of a respective resilient member 8′, 8″. During use, the fingers of the plurality of fingers 52′, 52″ of each coupling member 4, 6 engage a respective leg 86′, 88′, 86″, 88″. Therefore, as an example, a load applied to the first coupling member 4 is transferred to the second coupling member 6 via the plurality of fingers 52′ of the first coupling member, the first and second groups of resilient members 8′, 8″ and the plurality of fingers 52″ of the second coupling member. Advantageously, the resilient members act to absorb torsional vibration of the torque provided to the first coupling member 4.

To assemble the coupling 2, the resilient members of the first group of resilient members 8′ are positioned in respective recesses 20′ of the first coupling member 4 and the resilient members of the second group of resilient members 8″ are positioned in respective recesses 20″ of the second coupling member 4. The resilient members of the first and second groups of resilient members 8′, 8″ are positioned in the recesses of the plurality of recesses 20′, 20″ of the respective coupling member 4, 6 such that the projections 84′, 84″ of the resilient members are received by the channels 30′, 30″ of the respective coupling member 4, 6. Advantageously, by virtue of the engagement between the projections 84′, 84″ and the channels 30′, 30″, the likelihood that the resilient members of the first and second group of resilient members 8′, 8″ will ride out of the respective recess of the plurality of recesses 20′, 20″ in which the resilient members are received during use of the coupling 2 is reduced.

The first and second coupling members 4, 6 are then translated relative to one another such that the fingers of the plurality of fingers 52′ of the first coupling member 4 are received by the channels 90″ of the resilient members of the second group of resilient members 8″ and the fingers of the plurality of fingers 52″ of the second coupling member 6 are received by the channels 90′ of the resilient members of the first group of resilient members 8′. The chamfered surfaces 89′, 89″ of the legs 86′, 86″, 88′, 88″ make insertion of the fingers of the pluralities of fingers 52′, 52″ easier because the channels 90′, 90″ are widened at their opening by virtue of the chamfered surfaces. This allows easier locating of the fingers 52′, 52″ in their respective channel 90′, 90″. This translation is continued until the grooves 66′ of the first coupling member 4 are located axially to the second ends 96″ of the legs 86″, 88″ of the resilient members of the second group of resilient members 8″. In addition, translation is continued until the grooves (not visible in FIG. 6) of the second coupling member 6 are located axially to the second ends (not visible in FIG. 6) of the legs 86′, 88′ of the resilient members of the first group of resilient members 8′.

Next, the first retaining ring 10 is inserted into the grooves 66′ of the plurality of fingers 52′ of the first coupling member 4 and the second retaining ring 104 is inserted into the grooves (not visible in FIG. 6) of the fingers 52″ of the second coupling member 6. The retaining rings 10, 104 can be inserted using any suitable means. For example, where the retaining rings 10, 104 are circlips, the circlips can be inserted using circlip pliers.

The first retaining ring 10 abuts the end surfaces 106″ of the second ends 56″ of the plurality of fingers 52″ of the second coupling member 6. In addition, the first retaining ring 10 abuts the second ends 96″ of the legs 86″, 88″ of the resilient members of the second group of resilient members 8″. The second retaining ring 104 abuts the end surfaces (not visible in FIG. 6) of the second ends 56′ of the plurality of fingers 52′ of the first coupling member 4. In addition, the second retaining ring 104 abuts the second ends (not visible in FIG. 6) of the legs 86′, 88′ of the resilient members of the first group of resilient members 8′. Therefore, axial movement of the first coupling member 4 with respect to the second coupling member 6 is constrained by virtue of abutment of the first and second retaining ring 10, 104 with the end surfaces of the second ends 56′, 56″ of the fingers of the plurality of fingers 52′, 52″ of the respective one of the first and second coupling members 4, 6. In addition, axial movement of the resilient members of the first and second groups of resilient members 8′, 8″ is constrained by virtue of abutment of the retaining ring 10, 104 with the second ends 96″ of the legs 86′, 88′, 86″, 88″ of the resilient members of the respective group of the first and second groups of resilient members 8′, 8″.

Instead of positioning the first and second group of resilient members 8′, 8″ in the recesses of the pluralities of recesses 20′, 20″ and then translating the first and second coupling members 4, 6 relative to one another, assembly of the coupling 2 can be carried out in reverse. In the reverse method of assembly, the first and second coupling members 4, 6 are first translated relative to one another such that the fingers of the plurality of fingers 52′ of the first coupling member 4 are received by the recesses of the plurality of recesses 20″ of the second coupling member 6, and the fingers of the plurality of fingers 52″ of the second coupling member 6 are received by the recesses of the plurality of recesses 20′ of the first coupling member 4. Next, the first and second groups of resilient members 8′, 8″ are inserted into respective recesses of the pluralities of recesses 20′, 20″. This is possible by virtue of the recesses of the pluralities of recesses 20′, 20″ extending along the full axial length of the respective one of the first coupling member 4 and the second coupling member 6.

The recesses of the pluralities of recesses 20′, 20″ extending along the full axial length of the respective one of the first coupling member 4 and the second coupling member 6 also allows the resilient members of the first and/or second group of resilient members 8′, 8″ to be replaced in situ. This applies regardless of the method used to assemble the coupling 2. To replace a resilient member, the coupling 2 must first be stationary. A user of the coupling 2 can then remove the first and/or second retaining ring 10, 104. The retaining ring(s) removed will be determined by which resilient member(s) require replacement. To replace a resilient member of the first group of resilient members 8′, the second retaining ring 104 should be removed. To replace a resilient member of the second group of resilient members 8″, the first retaining ring 10 should be removed. Next, the resilient member(s) that require replacement are removed from the coupling 2. New resilient members are then inserted to replace the resilient member(s) that have been removed from the coupling. Finally, the retaining ring(s) are reinserted. Being able to replace resilient members in situ is advantageous because the time taken to replace resilient members is reduced. In known couplings, the coupling members must be dismounted from the shafts that they are connected to Although the above description refers to the first and second coupling members 4, 6 each comprising a respective plurality of recesses and fingers and the coupling 2 comprising a plurality of resilient members 8, in other, non-depicted, embodiments, each coupling member can be provided with a single finger and a single recess, with a single resilient member being received by the recess of one of the coupling members.

In some embodiments, the coupling can be provided with a cover. The cover can enclose the coupling members, the resilient members and the retaining rings of the coupling. The cover may be used when the coupling is being used in an environment where food or pharmaceutical products are being produced.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below. The depicted embodiments of the present invention are in order to assist in the understanding of the invention, which is defined in the appended claims.

1-25. (canceled)

26. A mechanical coupling comprising:
a first coupling member and a second coupling member, said first and second coupling members each comprising:
a body having a first end and an opposed second end, the body defining a central axis;
at least one finger that extends from the body in the direction of the central axis; and
a recess that extends radially into the body, the recess extending between the first end and the second end of the body, said recess having a base, the base of the recess comprising at least one channel;
the coupling further comprising a first resilient member received in the recess of the first coupling member and a second resilient member received in the recess of the second coupling member;
wherein the first and second resilient members each comprise at least one projection which is configured to be received by the channel of the recess of the respective first coupling member or of the second coupling member.

27. The mechanical coupling of claim 26, wherein the shape of the projection of each resilient member is complementary to the shape of the channel of the recess.

28. The mechanical coupling of claim 26, wherein the recess extends from a first end face of the first end to a second end face of the second end the respective body.

29. The mechanical coupling of claim 26, wherein the channels extend from the first end face to the second end face of the respective body of the first coupling member and/or the second coupling member.

30. The mechanical coupling of claim 26, wherein the fingers comprise a free first end and a second end, the second end being connected to the respective body.

31. The mechanical coupling of claim 26, wherein the finger of the first coupling member and/or the finger of the second coupling member comprise a respective groove, the groove of each finger being located adjacent to an end surface of the respective finger, wherein the grooves are configured to receive a retaining ring.

32. The mechanical coupling of claim 31, further comprising a first retaining ring received in the groove of the first coupling member and a second retaining ring received in the groove of the second coupling member.

33. The mechanical coupling of claim 26, wherein the fingers are located radially outwards of a respective body; and/or wherein
the first member and the second member comprise a plurality of fingers, the plurality of fingers of the first member interdigitating with the plurality of fingers of the second member.

34. The mechanical coupling of claim 26, wherein the channel of the first coupling member and the channel of the second member define respective sidewalls.

35. The mechanical coupling of claim 34, wherein the sidewalls extend parallel to one another

36. The mechanical coupling of claim 26, wherein the first and second resilient members each comprise a central portion having a first side and an opposed second side, and two legs that extend from the first side and define a channel therebetween.

37. The mechanical coupling of claim 36, wherein the legs of the first and second resilient members each define a first end that faces a central portion of the coupling and an opposed second end.

38. The mechanical coupling of claim 37, wherein each leg comprises a location feature, the location feature being adjacent to the first end of the respective leg.

39. The mechanical coupling of claim 37, wherein the finger of the first coupling member and/or the finger of the second coupling member comprise a respective groove, the groove of each finger being located adjacent to an end surface of the respective finger, wherein the grooves are configured to receive a retaining ring, wherein the second end of the legs of the first resilient member is located axially adjacent to the groove of the finger of the second member, and wherein the second end of the legs of the second resilient member is located axially adjacent to the groove of the finger of the first member.

40. The mechanical coupling of claim 39, wherein the second end of the legs of the first and second resilient members are configured to abut a respective retaining clip.

41. The mechanical coupling of claim 36, wherein the second end of the legs of the first and second resilient members are axially spaced apart from the second end of the respective central portion.

42. The mechanical coupling of claim 36, wherein the first end of the first side of the central portion of each of the first and second resilient members comprises a chamfer.

43. The mechanical coupling of claim 26, wherein the projection of the first and second resilient members extends along a full axial length of the respective resilient member.

44. A coupling member for a mechanical coupling, the coupling member comprising:
a body having a first end and an opposed second end, the body defining a central axis;
at least one finger that extends from the body in the direction of the central axis; and
a recess that extends radially into the body, the recess extending between the first end and the second end of the body, said recess having a base, characterised in that the base of the recess includes a channel.

45. A resilient member for use in a mechanical coupling, said resilient member including a central portion that defines a first side and a second side, and a projection which projects from the second side of the central portion.

46. A resilient member according to claim 45, the resilient member further comprising a central portion having a first side and an opposed second side, two legs that extend from the first side of the central portion and that define a channel therebetween.

47. A mechanical coupling comprising:
a first coupling member and a second coupling member, said first and second coupling members comprising:
a body having a first end and an opposed second end, the body defining a central axis;
at least one finger that extends from the body in the direction of the central axis, the at least one finger comprising a groove configured to receive a retaining ring; and
a recess that extends radially into the body, the recess extending between the first end and the second end of the body,
the coupling further comprising at least one resilient member disposed between the first coupling member and the second coupling member, wherein the mechanical coupling includes a retaining ring received in the groove of the at least one finger and wherein the retaining ring is configured to retain the at least one resilient member.

48. The mechanical coupling of claim 47, wherein the finger of the first coupling member and the finger of the second coupling member each comprise a free first end and a second end, the second end being connected to the respective body;
the groove of the finger of the first member is positioned axially beyond the second end of the finger of the second member and wherein the groove of the finger of the second member is positioned axially beyond the second end of the finger of the first member; and/or wherein
the mechanical coupling further comprises a first retaining ring received in the groove of the first coupling member and a second retaining ring received in the groove of the second coupling member.

49. A coupling member for a mechanical coupling, the coupling member comprising:
a body having a first end and an opposed second end, the body defining a central axis;
a recess that extends radially into the body, the recess extending between the first end and the second end of the body; and
at least one finger that extends from the body in the direction of the central axis;
wherein the at least one finger includes a groove that is configured to receive a retaining ring.

50. The coupling member of claim 49, further comprising a retaining ring received in the groove of the finger.
